(19) United States
(12) Patent Application Publication
(10) Pub. No.: US 2007/0186495 A1
(43) Pub. Date: Aug. 16, 2007

(54) Semi-removable window frame assembly

(76) Inventor: Christian Guillemette, Beauport (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/653,943

(22) Filed: Jan. 17, 2007

Related U.S. Application Data
(60) Provisional application No. 60/759,067, filed on Jan. 17, 2006.

(51) Int. Cl. E06B 3/32

(52) U.S. Cl. 52/204.51

(57) ABSTRACT

A window frame assembly is disclosed having an outer frame, an articulated sash retaining a first glazing and a semi-fixed sash retaining a second glazing. The outer frame includes a pair of vertical frame jambs, a frame header, a frame sill, and a horizontal cross framing member extending across the outer frame. The cross framing member has a top face, a bottom face and a groove extending along the top face. The articulated sash includes an articulating engagement with the outer frame and is operable to open with respect to the outer frame. The semi-fixed sash is positionable above the cross framing member and includes a pair of vertical stiles, a top rail, a bottom rail and a lip projecting downwardly from the bottom rail for engaging the groove, and a locking mechanism co-operable with the lip and groove for retaining the semi-fixed sash within the outer frame.

### FIELD OF THE INVENTION

The present invention relates generally to the field of windows and window frames. More particularly, it concerns a window frame assembly comprising a semi-fixed sash.

### BACKGROUND OF THE INVENTION

Modern window frames are presently available in a number of different designs and configurations. Casement, awning, picture, single-hung, double-hung, single-sliding, double-sliding, and bay windows each provide their own set of advantages and disadvantages when considering look, functionality and price.

For example, a conventional double-hung window includes two vertically disposed sashes capable of sliding vertically within the larger window frame. A single-hung window similarly includes two vertically disposed sashes, but only one of which is capable of sliding vertically within the window frame. To make opening the window easier, it is typically the upper sash which is fixed in the frame, and the lower sash which can slide vertically.

In a double-hung window, each of the sliding sashes is an articulated sash. An articulated sash is typically equipped with a hinge mechanism allowing it to partially release from the window frame and pivot with respect to the window frame, although other forms of articulation are possible. In use, the upper end of a sliding sash is freed from its vertical track and the sash is allowed to pivot inwards, thereby giving access to the exterior face of each glazing.

This feature allows both interior and exterior faces of double-hung windows to be cleaned from the inside. This can be quite advantageous for windows on the second storey and above, or for windows that are not easily accessible from the outside.

In addition, while double-hung windows are quite complex, they do offer a number of advantages during installation. Because the articulated sashes may be sealed prior to installation within the outer casing, this sealing can be done elsewhere in the building or even offsite. In this way, access to the outer face of the window frame is also granted without having to approach the window from the outside.

For single-hung windows, wherein only the lower sash is openable, it is much more difficult to access the exterior face of the glazing in the upper, fixed sash. In order to do so, one can open the window by sliding the lower sash upwards and reach outside from within in order to wash the window. If hanging out of the window in this manner is not feasible, the washer must approach the window from outside the building. During installation, and in some cases when repairing the window, the window must be approached from the outside to properly access the outer face of the window frame and seal the fixed glazing.

However, single-hung windows have many advantages over double-hung windows. For example, single-hung windows have a much simpler design, which reduces their cost of manufacture and assembly considerably. Because only one sash moves, a single-hung window requires half the track, locking and counter-weighting systems of a double-hung window. A double-hung window can easily cost 20% to 25% more than an equivalently sized single-hung window.

In addition, single-hung windows can be more aesthetically pleasing. From the exterior, they not only allow cleaner lines due to the lack of an outer track, but they require only half the mosquito screen since only half the window opens.

It is important to note that, while this background has thus far focused on hung windows as an example, these same trade-offs are made with respect to other types of windows, such as simple and double sliding windows, or any other configuration which utilises a movable sash and fixed sash in combination where two movable sashes could be used.

Indeed, such trade-offs are more broadly applicable when comparing any type of window frame with a movable sash (hung, sliding, casement, awning, or other) to a fixed frame design. A consumer facing such a choice must similarly consider the low price and simple design of a fixed-frame window in comparison to the convenience and functionality of an articulated sash window.

A previous attempt to solve this problem relates specifically to bay windows formed by a series of tall, thin windows arranged to approximate an arc. In such a series, the two windows at either end of the series are usually crank type windows which employ a crank mechanism, push-rod and pivot assembly to open the window. When opened, however, crank windows only give access to the exterior face of one of their neighbouring windows. Furthermore, if a large number of these tall, thin windows are employed then it becomes quite difficult to reach the central windows from either end. To provide better access to the exterior faces without significantly increasing the costs, a mock-crank window is installed in the middle of the series which retains the hinge and lock of a crank window, but does not include any of the crank or push-rod assemblies. In this way, the mock-crank windows can open when needed, but not in a controlled manner as provided by the crank and push-rod assemblies.

Thus far, a design has not been produced which can fully make use of the advantages of both the single-type and double-type configurations of various types of windows.

Known in the art are the following U.S. patents which disclose prior art single-hung window frames with removable sashes.

U.S. Pat. No. 6,293,049, issued Sep. 25, 2001 to Shaw, describes a single-hung window comprising a removable upper sash. The window comprises two sash supports fixed to the vertical jambs. A ledge is created between each sash support and the jamb to which it is fixed. This ledge is used to receive a flange which extends downwardly from the lower extremity of the upper sash. In addition, the sash supports include vertical slots which cooperate with corresponding web portions on the upper sash, further solidifying the engagement. The upper sash is removed by lifting it up, within the outer window frame in order to free the flanges from the sash supports.

U.S. Pat. No. 4,831,778, issued May 23, 1989 to Schmidt et al., also describes a single-hung window comprising a removable upper sash. In this design, support pieces are attached to the lower extremities of each stile of the upper sash. Each support piece includes a projection that fits into, and takes a position behind, a notch in a respective vertical jamb. Similarly, the upper sash is removed by lifting it up into an upper recess in the outer window frame in order to disengage the support pieces from the jambs.

Also known in the art are the various disadvantages associated with these types of conventional window frames. For example, such designs can be as complex and difficult to manufacture, and hence expensive, as standard double-hung windows. Moreover, the engagement between the removable upper sash and the outer casing are often too loose to provide adequate sealing against the elements or insulation.

Further known in the art are U.S. Pat. No. 2,509,582, issued Sep. 10, 1948 to Webster, and U.S. Pat. No. 3,122,797, issued Mar. 3, 1964 to Segre, which disclose double-hung windows wherein a sash is provided with downwardly projecting portions which fit into corresponding recesses in their outer casings. Both these patents teach a sash which is removed by lifting it into an upper recess in the outer frame in order to clear the projections from the recesses. The sash is then swung either outwards or inwards from the window frame and removed.

Also known in the art is United States Patent Application No. 2005/0210815, published Sep. 29, 2005, which discloses a window frame operable to receive a removable sash. The outer casing includes a lateral flange which projects inwardly and seals against the sash. Once assembled, the sash is retained within the window frame by a combination of spring flanges and an inner shoulder. The sash can be removed from the outer casing by prying it out of the casing with a sharp blade.

Thus, there remains a need for a window frame which allows easy removal of an a sash in order to access its interior and exterior faces like a double-hung window, but retains the aesthetic advantages and low cost of single-hung window.

Also known in the art are the following patents and published applications which also describe window frames and the like: U.S. Pat. No. 2,865,061, U.S. Pat. No. 2,934,799, U.S. Pat. No. 3,805,452, U.S. Pat. No. 4,283,883, U.S. Pat. No. 4,993,188, U.S. Pat. No. 5,592,781, U.S. Pat. No. 5,918,419, U.S. Pat. No. 6,698,139, U.S. Pat. No. 6,966,158, US 2005/0066582, US 2005/0091926.

### SUMMARY OF THE INVENTION

It is an object of the present invention to provide a window frame that satisfies the above-mentioned need.

According to a first aspect, that object is achieved with a window frame assembly comprising an outer frame, an articulated sash retaining a first glazing and a semi-fixed sash retaining a second glazing. The outer frame includes a pair of vertical frame jambs, a frame header, a frame sill, and a horizontal cross framing member extending across the outer frame. The cross framing member has a top face, a bottom face and a groove extending along the top face. The articulated sash includes an articulating engagement with the outer frame and is operable to open with respect to the outer frame. The semi-fixed sash is positionable above the cross framing member and includes a pair of vertical stiles, a top rail, a bottom rail and a lip projecting downwardly from the bottom rail for engaging the groove, and a locking mechanism co-operable with the lip and groove for retaining the semi-fixed sash within the outer frame.

According to a second aspect, that object is achieved with a window frame assembly comprising an outer frame an articulated sash retaining a first glazing and a semi-fixed sash retaining a second glazing. The outer frame includes a pair of vertical frame jambs, a frame header, a frame sill, and a vertical cross framing member extending across the outer frame. The cross framing member has a side face and a groove extending along the side face. The articulated sash includes an articulating engagement with the outer frame and is operable to open with respect to the outer frame. The semi-fixed sash is positionable beside the cross framing member and includes first and second vertical stiles, a top rail, a bottom rail and a lip projecting outwardly from the first vertical stile for engaging the groove, and a locking mechanism co-operable with the lip and groove for retaining the semi-fixed sash within the outer frame.

As can be appreciated, a window frame assembly according to the present invention can advantageously combine the simplicity and low cost of a single-hung window, and the ease of installation and access to the exterior side of both sashes.

In accordance with a preferred variant, the sills and rails of the semi-fixed sash each have a U-shaped construction formed by an inner wall, a bottom wall and an outer wall. Preferably, the cross framing member comprises a back plate projecting upwardly from its top face. In such a case, the outer wall of the bottom rail abuts against the back plate and the bottom wall of the bottom rail rests on the top face. Preferably again, the lip is part of a locking bar which is insertable within a receiving channel provided in the bottom wall of the bottom rail.

For the sake of clarity, it is worth mentioning that throughout the following description the terms such as inside and outside, inner and outer, and interior and exterior used in relation to the walls or faces of the window frame assembly are defined relative to the interior and exterior of the building embodying the window frame assembly. However, the expressions inner and outer when used in relation to the surfaces of the jambs, header, sill, rails or stiles are defined relative to the central area of the window. Furthermore, the pair of vertical frame jambs, the frame header and the frame sill may be referred to collectively as the “members” of the outer frame.

### BRIEF DESCRIPTION OF THE DRAWINGS

Other objects and advantages of the invention will become apparent upon reading the detailed description and upon referring to the drawings in which:

FIG. 1 is an isometric representation of a window frame assembly in an open position according to a preferred embodiment of the present invention.

FIG. 2 is a detailed view of a cross-section taken along line II-II in FIG. 1.

FIG. 3 is a detailed view of a cross-section taken along line II-II in FIG. 1, according to a further embodiment of the present invention.

FIG. 4 is a front view of a window frame assembly in a closed position according to another preferred embodiment of the present invention.

FIG. 5 is a perspective view of an attachment mechanism according to a preferred embodiment of the present invention.

While the invention will be described in conjunction with exemplary embodiments, it will be understood that these are not intended to limit the scope of the invention to such embodiments. On the contrary, the invention is intended to cover all alternatives, modifications and equivalents as may be included as defined by the appended claims.

### DESCRIPTION OF PREFERRED EMBODIMENTS

In the following description, similar features in the drawings have been given similar reference numerals and in order to lighten the figures, some elements are not referred to in some Figures if they were already identified in a preceding Figure.

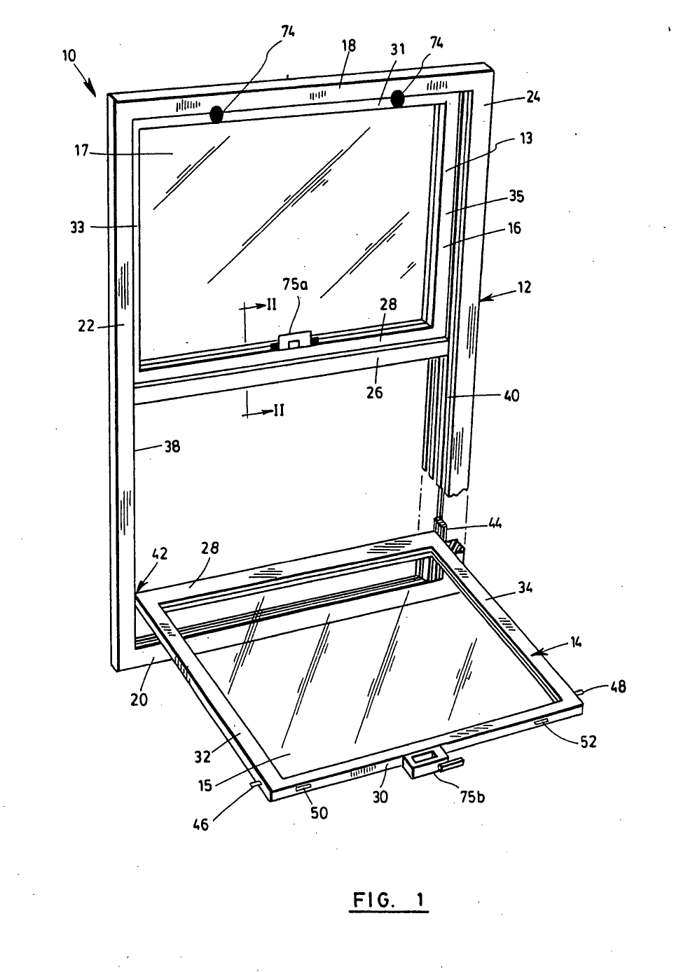

In FIG. 1, a window frame assembly 10 is illustrated comprising an outer frame 12 which retains a lower, articulated sash 14 and an upper, semi-fixed sash 16. The outer frame 12, also called a casing, is installed in a building wall (not shown). It comprises a frame header 18, a frame sill 20, and left and right vertical frame jambs 22 and 24, which form its upper, lower, left and right sides, respectively. A horizontal cross framing member 26, also called a crossbar, is further provided which extends across the casing 12. The articulated sash 14 comprises a bottom rail 28, a top rail 30, and left and right vertical stiles 32 and 34. The semi-fixed sash similarly comprises a bottom rail 29, a top rail 31, and left and right vertical stiles 33 and 35. The sashes 14 and 16 each comprise a transparent pane, such as a first glazing 15 and a second glazing 17. The glazings 15 and 17 generally divide the assembly 10 into an interior side which faces the interior of the building and an exterior side which faces the exterior of the building. FIG. 1 illustrates generally the interior side of the assembly 10, however because the articulated frame 14 has been swung inwards it is its exterior side which is shown.

The semi-fixed sash 16 is positioned in a semi-fixed sash receiving portion 13 formed between the frame header 18, the left and right jambs 22 and 24 and the crossbar 26. It generally remains fixed in the receiving portion 13, although because of its engagement with the casing 12, it can be easily removed for cleaning or repair purposes, or the like, as will be discussed in further detail below. As with most conventional hung windows, the articulated sash 14 is operable to translate vertically within the frame 10 along a pair of tracks 38 and 40 which extend vertically along the inner surfaces of the left and right jambs 24, in front of the crossbar 26 and semi-fixed sash 16. When the articulated sash 14 is slid into its uppermost position and the overlap between the sashes 14 and 16 and their respective glazings 15 and 17 is thereby maximised, the window frame assembly 10 is considered to be fully open with respect to the casing 12.

In order to maintain the vertical position of the articulated sash 14, a counterweight system is provided within the left and right jambs 22 and 24. Such systems are generally known in the art and will not be discussed here in further detail.

In addition, the articulated sash 14 can be swung inwards, as is also common in conventional hung windows. The sliders 42 and 44 are pivotally attached to the articulated sash 14, thereby further enabling the sash 14 to pivot with the respect to the casing 12.

A pair of release pins 46 and 48 are provided in proximity to the upper rail 30. The release pins 46 and 48 work in conjunction with the sliders 42 and 44 to keep the articulated sash 14 within the casing 12. The pins 46 and 48, which project laterally from the intersections of the upper rail 30 and left and right stiles 32 and 34, are also operable to engage the vertical tracks 38 and 40. The pins 46 and 48 are linked internally with a corresponding pair of release tabs 50 and 52 that are located on the upper surface of the upper rail 30. They enable a user to retract the pins 46 and 48, thereby freeing them and the upper end of the articulated sash 14 from the tracks 38 and 40.

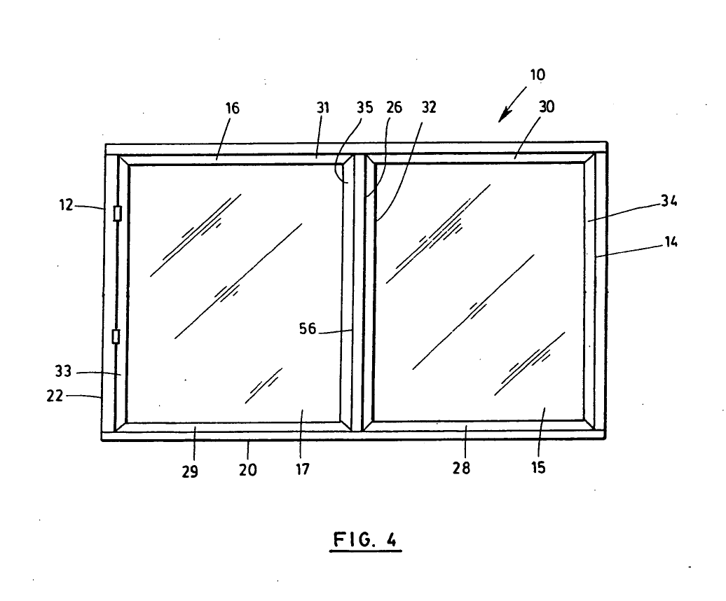

As will be apparent to one of ordinary skill in the art, the precise manner of articulation of the articulated sash 14 described hereinabove is not to be considered limiting. Rather, the articulated sash 14 may be considered to encompass any other conventional sash which is operable to translate, rotate or otherwise change position with respect to the casing 12. Indeed, it is important to note that, while this description has thus far used hung windows as an example, other types of windows, such as simple and double sliding, casement, and awning windows are within the scope of the invention. More specifically, it will be apparent to one of ordinary skill in the art that the structure which enables the vertical translation of a hung window can be quite easily adapted to enable the horizontal translation of a sliding window, as will be discussed in further detail in connection with FIG. 4.

If the window frame assembly 10 were a conventional double-hung window, the upper sash 16 would necessarily comprise an equivalent system of sliders, release pins and release tabs to enable it to perform the same vertical sliding and inward pivoting articulation as described above with respect to articulated sash 14. Were the window frame assembly 10 a single-hung window, the upper sash 16 would simply be fixed in place. In such a case, the lower rail 28, the upper rail 30, the left and right stiles 32 and 34 of the upper sash 16 would be integral parts of the casing 12.

When retained in the casing 12, the semi-fixed sash 16 is positioned within the receiving portion 13 so that it rests on the crossbar 26. A locking mechanism 74 is provided on the interior side of the casing 12 for helping retain the semi-fixed sash 16 in place, as illustrated in FIG. 1. Preferably, the locking mechanism 74 is a pair of tabs located along the header 18 of the casing 12. These tabs 74 are attached to the casing 12 so as to rotate about an axis perpendicular to the plane of the window frame assembly 10. The tabs 74 each comprise an eccentric portion extending away from this axis. By rotating the tabs 74 such that they extend over the top rail 30 of the semi-fixed sash 16, the upper portion of the semi-fixed sash 16 may be blocked from travelling inwards while the frame 12 itself blocks the semi-fixed sash 16 from travelling outwards by a back plate 54 discussed in further detail below. Additional elements of the window frame assembly 10 are then used to further engage and retain the bottom rail 29 of the semi-fixed sash 16, which will be discussed in further detail below. With the semi-fixed sash 16 retained by the tabs 74, the articulated sash is free to translate freely along the tracks 38 and 40.

When the window assembly 10 is fully closed, the articulated sash 14 is fully upright, the release pins 46 and 48 are in engagement with the tracks 38 and 40, the articulated sash 14 is in its bottommost position within the casing 12, and the semi-fixed sash 16 is held within the receiving portion 13. The bottom rail 29 of the semi-fixed sash 16 and the top rail 30 of the articulated sash 14 include complementary portions 75a and 75b of a sash lock for retaining the articulating sash 14 in the fully closed position and thereby securely locking the window assembly 10 from the inside. The sash lock 75a and 75b is preferably a standard sash lock, as would be used on a conventional single-, or double-hung window.

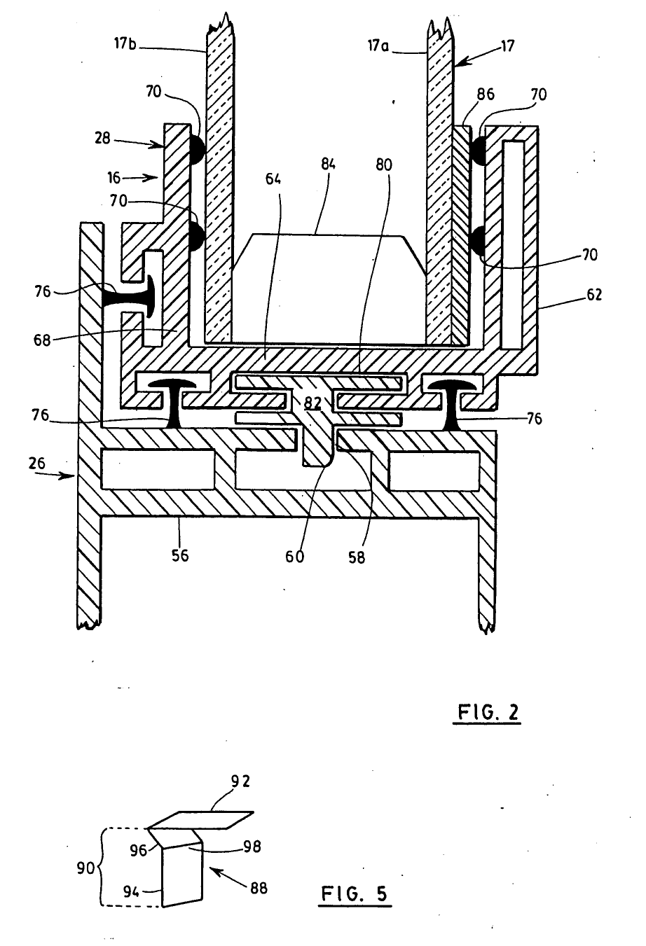

With reference now to FIG. 2, the crossbar 26 comprises a top face 56 upon which the semi-fixed sash 16 sits, a bottom face 57, a back plate 54 projecting upwardly from the top face 56, and a groove 58 which opens along the top face 56 and extends between the top and bottom faces 56 and 58. The lower rail 28 of the semi-fixed sash 16 is U-shaped and is formed by an inner wall 62, a bottom wall 64 and an outer wall 68. These three walls combine to retain the lower edge of the second glazing 17.

The bottom wall 64 comprises a receiving channel 80 which receives and retains a locking bar 82 comprising a downwardly extending lip 60. When the semi-fixed sash 16 is within the receiving portion 13, the lip 60 is aligned with the groove 58 and fits therein, the bottom wall 64 of the sash 16 sits on the top face 56 of the crossbar 26, and outer wall 68 rests against the back plate 54. The fit between the sash 16 and the semi-fixed sash receiving portion 13 is close enough to allow for a minimal amount of movement therebetween and a proper insulation, while allowing an ease of entry and exit of the sash 16.

Seals 70 are provided between the inner and outer rail walls 62 and 68 and the glazing 17, as is known in the art. The glazing 17 is a thermally insulated window comprising two panes 17a and 17b which are separated by a spacer 84.

In order to ensure a proper insulation, weather-strippings 76 is provided on the semi-fixed sash 16. Preferably, at least one of the weather-strippings 76 is provided extending downwardly from the bottom wall 64, and outwardly from the outer wall 68. More preferably, a downwardly extending weather-stripping 76 is located on either side of the receiving channel 80 and locking bar 82.

While only the lower rail 28 has been shown in cross-section, it is preferable that the construction of the upper rail 30 and the left and right stiles 32 and 34 be equivalent. It is also preferable that the construction of the remaining members of the casing 12, or more particularly the sash receiving portion 13, be similarly equivalent to that illustrated in FIG. 2 inasmuch as they include back plates 54 and top faces 56 for engaging similarly equivalent weather-stripping 76 and sealing the window assembly 10. In addition, it is a back plate 54 extending downwardly from the frame header 18 which works in conjunction with the tabs 74 to secure the top rail 31, as referred to above.

The locking bar 82 and groove 58, however, need only be provided along one of the four sides of the sash 16 and the sash receiving portion 13.

It is worth noting here that the relative positions of the locking bar 82 and the locking mechanism 74 are not accidental. In order to cooperate most effectively to retain the semi-fixed sash 16 within the receiving portion 13, the locking bar 82 and locking mechanism 74 are preferably located opposite one another on the sash 16 and the casing 12. As such, were the locking bar 82 and corresponding groove 58 located along the left stile 22 and left jamb 33 then the locking mechanism would preferably be located on the right jamb 24 in order to engage the right stile 35. Such arrangements are not, however, essential to the functioning of the window frame assembly 10 and other arrangements and types of locking mechanisms are within the scope of the invention.

The inner wall 62 of any or all of the rails 29 and 31 and the stiles 33 and 35 are preferably operable to receive window accessory elements, such as handles, buttons, connectors, locks, or sensors. This reception is preferably assisted by providing a double layered inner wall 62 comprising a void space 72. As such, elements such as these can be affixed via, for example, screws, bolts, adhesive, pegs, or other conventional fixing means to the inner wall 62.

In this manner, semi-fixed sash 16 is not articulated like sash 14 (i.e. it cannot slide vertically, nor can it be pivoted inwards). However, semi-fixed sash 16 can be removed from casing 12 when needed (for example, for cleaning or during installation and repair). In addition, the window frame assembly 10 maintains all of the aesthetic advantages associated with single-hung windows, but only costs approximately 5% more.

Furthermore, a strengthening strip 86 may be disposed within the semi-fixed sash 16. Because of the simple U-shaped design of the lower rail 28 (and, similarly, the upper rail 30, and the left and right stiles 32 and 34), the strengthening strip 86 may be provided to further strengthen and rigidify the semi-fixed sash 16. The strengthening strip 86 can be formed from a metal or denser plastic, and is preferably provided all the way around the semi-fixed sash 16. As illustrated in FIG. 2, the strengthening strip 86 is disposed between the glazing 17 and the inner wall 62. In an alternate embodiment, a strengthening strip can be inserted into the receiving channel 80. The stiffness of the strengthening strip 86 can be increased by providing a bead which is either moulded or rolled along its length, as is known in the art.

Preferably, a pair of grooves 58 are provided, each groove 58 extending approximately two inches in length and located approximately two inches from either jamb 22 and 24 along the top face 56. Correspondingly, a pair of locking bars 82 are preferably provided, each locking bar 82 being dimensioned and aligned in accordance with a respective groove 58. The locking bars 82 may be force fit and/or glued into position along the receiving channel 80.

While the members of the semi-fixed sash 16 are readily manufactured from extruded plastic, such as polyvinyl chloride (commonly known as PVC), in the form illustrated in cross-section in FIG. 2, the remaining elements of the window frame assembly 10, notably the articulating sash 14, the casing 12 and the crossbar 26, can be fabricated from standard, pre-existing single-hung window designs and dies. From a manufacturing perspective, this is enormously beneficial as moulds and dies for PVC window frames can cost in the millions of dollars.

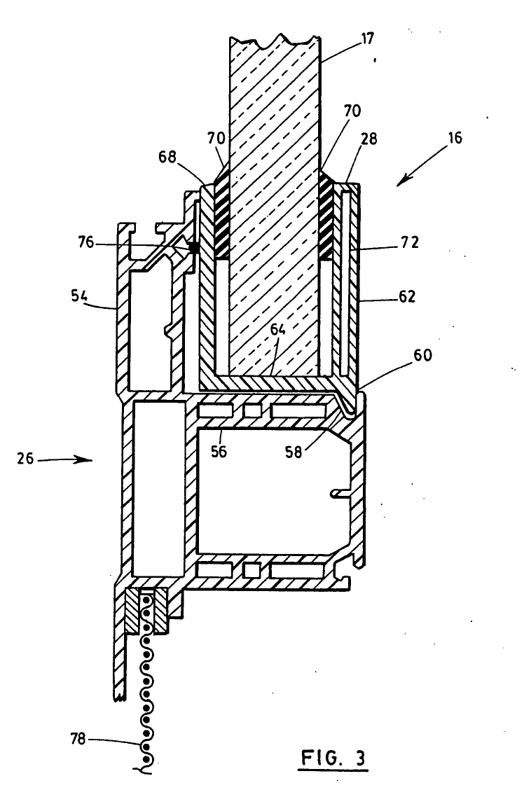

With reference now to FIG. 3, an alternative embodiment of the present invention is illustrated. In this embodiment, the lip 60 extends downwardly from the bottom wall 64 of the bottom rail 29, substantially an extension of the inner wall 62. The lip 60 may also extend the length of the bottom rail 29. Correspondingly, the groove 58 is aligned with the lip 60 along the interior of the top face 56 of the crossbar 26. In this alternate embodiment, a groove normally used with fixed glazing windows can be advantageously be utilised. In conventional fixed-frame designs, glass beads are used to retain the glazing in the frame. The glazing is assembled in a frame of similar construction to the crossbar 26 illustrated in FIG. 3, and four glass beads (assuming a standard, rectangular window) are forced into grooves located along the header, sill and jambs of the frame in order to lock the glazing in place. This glass bead groove can be used to receive the lip 60, therefore once again enabling the use of pre-existing designs and moulds.

In this case, the weather-stripping 76 is provided extending inwardly from the back plate 54 to seal against the outer wall 68.

Lastly, a screen 78 is housed below crossbar 26. The screen 78 can serves to keep insects and animals from entering through the window frame assembly 10 when the articulated sash 14 is in an open position. The screen 78 is removable from window frame assembly 10 in the conventional manner, such that it can be stored when not needed.

As noted above, the above-described window frame structure is also applicable to other types of window frame assemblies, for example a sliding-type window frame assembly 10 as illustrated in FIG. 4. As in the previous embodiment, a semi-fixed window frame assembly comprises a casing 12 which retains an articulated sash 14 and a semi-fixed sash 16. The casing 12 comprises a frame header 18, a frame sill 20, left and right vertical jambs 22 and 24, and a vertical crossbar 26. The articulated sash 14, which is operable to open with respect to the casing 12 by sliding horizontally within the casing 12, comprises a bottom rail 28, a top rail 30 and left and right vertical stiles 32 and 34. The semi-fixed sash 16 comprises a bottom rail 28, a top rail 30 and left and right vertical stiles 32 and 34. In this embodiment, however, a lip 60 (not show) is provided along the right stile 35 and engages the groove 58 (also not shown) in a side face 56 of the crossbar 26. Accordingly, the locking mechanism 74 is located along the left jamb 22 and engages the left stile 33.

In addition, the rails 29 and 31, and stiles 32 and 34 can be mechanically fastened to form the semi-fixed frame 16, due to their simple, U-shaped design, further reducing the cost. For example, an optional attachment mechanism 88 is illustrated in FIG. 5 and comprises a first tang 90 and a second tang 92. The first tang 90 further comprises a first portion 94 and a second portion 96, divided along a bend 98. The attachment mechanism 88 is preferably made of bent sheet metal. Other, conventional mechanical fastening devices, methods and materials may also be used.

During assembly, two adjacent members (i.e. a stile and a rail) of the semi-fixed sash 16 are aligned at 90° to one another. The first portion 94 of the first tang 90 is slid into the receiving channel 80 of one of the two members, which is slightly larger than the width of the first tang 90, up to the bend 98. The second tang 92 is then slid into the receiving channel 80 of the remaining member. A force is then applied to attachment mechanism 88, for example by hammer, in direction 100 to the second portion 96 of the first tang 90. The first tang 90 is thereby unbent so that the first and second portions 94 and 96 are now co-planar. This process is repeated for each of the four corners of semi-fixed sash 16, thereby fixedly retaining the glazing 17. The attachment mechanism 88 may be used alone or in conjunction with an adhesive.

The semi-fixed sash 16 trades the ability to translate and open inwards of an articulated sash, which require a far more robust construction, for the frugal construction taught above all the while providing a window assembly 10 which overcomes many of the difficulties and drawbacks associated with single-hung windows.

Such a construction, enabled by the simple, U-shaped design of the semi-fixed sash 16, is in sharp contrast to that of articulated sashes, like lower sash 14, which often require much more sizable construction in order to properly ensure sufficient insulation and rigidity. In addition, such frames must be fused together, adding additional labour and manufacturing costs. In addition, the presence of a crossbar 26 not only simplifies design, since it too can be manufactured from existing frame models, but it also results in a window assembly 10 which is more structurally and thermally sound than existing single-hung designs which include removable sashes.

The above description of preferred embodiments of the present invention should not be read in a limitative manner as refinements and variations are possible without departing from the spirit of the invention. The scope of the invention is defined in the appended claim and its equivalents.

1. A window frame assembly comprising:
a) an outer frame having:
i) a pair of vertical frame jambs, a frame header, a frame sill; and
ii) a horizontal cross framing member extending across the outer frame, the cross framing member having a top face, a bottom face and a groove extending along the top face;
b) an articulated sash retaining a first glazing, the articulated sash comprising an articulating engagement with the outer frame, the articulated sash being operable to open with respect to the outer frame;
c) a semi-fixed sash retaining a second glazing and positionable above the cross framing member, the semi-fixed sash including:
i) a pair of vertical stiles, a top rail, a bottom rail and a lip projecting downwardly from the bottom rail for engaging the groove; and
ii) a locking mechanism co-operable with the lip and groove for retaining the semi-fixed sash within the outer frame.

2. The window frame assembly of claim 1, wherein the bottom rail of the semi-fixed sash has a U-shaped construction formed by an inner wall, a bottom wall and an outer wall.

3. The window frame assembly of claim 2, wherein the cross framing member comprises a back plate projecting upwardly from the top face, the outer wall of the bottom rail abutting against the back plate and the bottom wall of the bottom rail resting on the top face of the cross framing member.

4. The window frame assembly of claim 2, wherein the lip is part of a locking bar insertable within a receiving channel provided in the bottom wall of the bottom rail.

5. The window frame assembly of claim 2, wherein the semi-fixed sash comprises at least one weather-stripping element extending downwardly from the bottom wall of the bottom rail for sealingly engaging the top face.

6. The window frame assembly of claim 3, wherein the semi-fixed sash comprises at least one weather-stripping element extending outwardly from the outer wall of the bottom rail for sealingly engaging the back plate of the cross framing member.

7. The window frame assembly of claim 2, wherein at least one of the inner walls is operable to receive an element selected from the group comprising handles, locks, buttons, connectors, and sensors.

8. The window frame of claim 7, wherein the inner wall is a double layered wall comprising a void space.

9. The window frame of claim 7, wherein the locking mechanism comprises a tab pivotally mounted on the frame header operable to releasably engage the top rail of the semi-fixed sash.

10. The window frame of claim 7, wherein the bottom rail of the semi-fixed sash and a top rail of the articulated sash comprise complementary portions of a sash lock operable to lock the articulating sash.

11. The window frame of claim 2, wherein the top rail and the pair of vertical stiles each have a U-shaped construction formed by an inner wall, a bottom wall and an outer wall.

12. A window frame assembly comprising:
a) an outer frame having:
i) a pair of vertical frame jambs, a frame header, a frame sill; and
ii) a vertical cross framing member extending across the outer frame, the cross framing member having a side face and a groove extending along the side face;
b) an articulated sash retaining a first glazing, the articulated sash comprising an articulating engagement with the outer frame, the articulated sash being operable to open with respect to the outer frame;
c) a semi-fixed sash retaining a second glazing and positionable beside the cross framing member, the semi-fixed sash including:
i) first and second vertical stiles, a top rail, a bottom rail and a lip projecting outwardly from the first vertical stile for engaging the groove; and
ii) a locking mechanism co-operable with the lip and groove for retaining the semi-fixed sash within the outer frame.
